(19) United States
(12) Patent Application Publication
(10) Pub. No.: US 2008/0021912 A1
(43) Pub. Date: Jan. 24, 2008

(54) Tools and methods for semi-automatic schema matching

(75) Inventors: Leonard J. Seligman, Silver Spring, MD (US); Peter D.S. Mork, Rockville, MD (US); Joel G. Korb, Arlington, VA (US); Kenneth B. Samuel, McLean, VA (US); Christopher S. Wolf, Fairfax, VA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: The MITRE Corporation

(21) Appl. No.: 11/491,167

(22) Filed: Jul. 24, 2006

(51) Int. Cl. G06F 7/00; G06F 17/00

(52) U.S. Cl. 707/101

(57) ABSTRACT

Tools and methods for schema matching that generate schema graphs, populate match matrices and display the schema graphs and the match matrices. These tools and methods characterize potential matches between disparate schemata in terms of both a strength of evidence indicating the potential match and an amount of evidence indicating the potential match. A number of match voters generate a set of match scores for each potential match, and these match scores are combined by a vote merger to form a single confidence value for each potential match. A number of filters display the confidence value for each potential match as a link on a graphical user interface. Machine-learning techniques may be employed to adaptively determine confidence values based on previously established matches.

### BACKGROUND OF THE INVENTION

1. Field of the Invention

The present invention relates generally to the field of data integration. More specifically, the present invention relates to identifying semantic correspondences between disparate schemata.

2. Background Art

Data integration is a key part of any endeavor involving the interoperation of independently-developed systems, as data models used by these systems typically assume different syntax and semantics. To pass data from a source system to a target system, an integration engineer must develop and deploy executable code to transform data instances that ascribe to the source model into data instances that ascribe to the target model. This task is known as schema integration, and it represents the first step in developing a data integration solution. Once an executable mapping has been implemented, the integration engineer must then determine which source and target instances reference the same real-world entities (instance integration) and finally deploy the solution.

Schema integration consists of four interrelated subtasks. The integration engineer must first acquire the source and target schemata and any associated documentation. Second, the integration engineer must identify, at a high level, semantic correspondences between the source and the target schemata. This task is known as schema matching. Third, these correspondences are used to establish precise transformations that define a schema mapping from the source to the target. Finally, these transformations are assembled into executable code that, given a source instance, generates a target instance.

Researchers have built numerous systems that semi-automatically perform schema matching (see Rahm, et al., “A Survey of Approaches to Automatic Schema Matching,” The VDLB Journal, vol. 10, pp. 334-350, 2001, incorporated herein by reference in its entirety). Representative examples of these research tools include Clio (see Miller, et al., “The Clio Project: Managing Heterogeneity,” SIGMOD Record, vol. 30, pp. 78-83, 2001, incorporated herein by reference in its entirety) and COMA++ (see Aumueller, et al., “Schema and ontology matching with COMA++,” presented at Proceedings of the ACM SIGMOD International Conference on Management of Data, Baltimore, Md., 2005, incorporated herein by reference in its entirety).

Further, a number of manual schema matching tools have been developed by commercial vendors, including Altova's MapForce (see http://www.altova.com/products/mapforce/data_mapping.html, incorporated herein by reference in its entirety), BEA's AquaLogic (see http://www.bea.com/framework.jsp?CNT=index.htm&FP=/content/products/a qualogic/, incorporated herein by reference in its entirety), and Stylus Studio's XQuery Mapper (see http://www.stylusstudio.com/xquery_mapper.html, incorporated herein by reference in its entirety).

These existing schema-matching tools generally decompose the source and target schemata into corresponding schema graphs, the nodes of which correspond to schema elements and the edges of which correspond to relationships among the elements. Based on this decomposition, schema matching involves identifying all pairs of source and target schema elements such that a semantic correspondence exists between the source element and the target element. A semantic correspondence indicates that instances of the source element can be used to generate instances of the target element.

These correspondences are commonly represented as a match matrix that contains one row for each source element and one column for each target element. Each cell of the match matrix contains a numeric value that indicates the extent to which the source element matches the target element. If there is definitely a semantic correspondence, this value is +1 and if there is not a semantic correspondence, this value is −1. Other values indicate varying degrees of uncertainty.

Existing tools for semi-automatic schema matching typically determine the strength of a potential match between the source and the target schema element by computing a ratio of positive evidence (i.e., evidence indicating a match exists) to total evidence (i.e., all available evidence). This ratio, and the standard approaches which employ it, implicitly ignore the quantity of total evidence available for consideration. Using existing tools, a potential. match may be identified with a high degree of certainty (i.e., ±1) even if there were only a negligible amount of positive evidence indicating a match.

Further, the existing schema-matching tools generally display the match matrix as a collection of color-coded links between the source and the target schema elements. These links are used by the integration engineer to explicitly accept or reject potential matches, thus identifying semantic correspondences. Because a match score is established between every pair of elements, this visualization can quickly become overwhelming for the integration engineer. The existing schema-matching tools, whether commercially-developed or research-based, generally lack the capability to display a filtered set of potential correspondences.

The existing schema-matching tools are generally adjustable only after a particular schema-matching task is complete. These tools are unable to dynamically tune their operational parameters to reflect the semantic correspondences established during the schema-matching task. Thus, existing schema-matching tools implicitly ignore potential feedback from established semantic correspondences.

### BRIEF SUMMARY OF THE INVENTION

In one aspect, the invention is a schema-matching tool for establishing correspondences between data elements on disparate schemata. The schema-matching tool accepts as input at least one source schema and at least one target schema. A set of match scores is then generated by the schema-matching tool to represent potential correspondences between elements in the source schemata and elements in the target schemata. The match scores may reflect any combination of the amount of evidence for a potential correspondence and the strength of that evidence. The match scores may be computed by several different match algorithms called match voters. The match scores are then combined to yield a confidence value for each potential correspondence, and each confidence value is then displayed.

The schema-matching tool may also include a graphical user interface (GUI) for displaying and modifying semantic correspondences. Because of the large number of potential correspondences, the GUI may allow the integration engineer to limit which correspondences are shown onscreen. These filters include node filters that display only those schema elements meeting certain criteria and link filters that display only those correspondences that meet certain criteria. The GUI may also allow the integration engineer to accept or reject correspondences proposed by the match voters. The confidence values for each of the potential correspondences may be adaptively determined in response to previously established semantic correspondences between the elements in the source schemata and the elements in the target schemata.

In another aspect, the invention is a method for establishing correspondences between data elements on disparate schemata. The schema method accepts as input at least one source schema and at least one target schema. A set of match scores is then generated to represent potential correspondences between elements in the source schemata and elements in the target schemata. The match scores may reflect a combination of the amount of evidence for a potential correspondence and the strength of that evidence. The match scores may be computed by several different match algorithms called match voters. The match scores are then combined to yield a confidence value for each potential correspondence, and each confidence value is then displayed.

The schema method may also include a graphical user interface (GUI) for displaying and modifying semantic correspondences. Because of the large number of potential correspondences, the GUI may allow the integration engineer to limit which correspondences are displayed on the GUI. These filters include node filters that display only those schema elements meeting certain criteria and link filters that display only those correspondences that meet certain criteria. The GUI may also allow the integration engineer to accept or reject correspondences proposed by the match voters. The confidence values for each of the potential correspondences may be adaptively determined in response to previously established semantic correspondences between the elements in the source schemata and the elements in the target schemata.

A need thus exists for semi-automatic tools and methods for schema matching that examine potential matches not only on the strength of available evidence (e.g., through a ratio), but also on the quantity of available evidence. These tools and methods embrace multiple strategies to assess a potential semantic correspondence and collapse the results of these multiple strategies into a single metric that characterizes the strength of a potential correspondence. Further, these tools and methods alleviate the burden placed on the integration engineer by incorporating additional tools and methods that focus the integration engineer on particular classes of potential matches. These tools and methods also incorporate machine-learning techniques to calibrate the semi-automatic schema matching process to reflect the explicitly accepted and rejected matches.

These tools and methods greatly improve upon the accuracy of existing semi-automatic schema-matching techniques, as they assess potential matches based on both the quality of evidence and on the quantity of evidence. Thus, using these tools and methods, a potential match could be deemed inconclusive not only because of conflicting evidence, but because there is no evidence to consider. This capability leads to potential correspondences that more accurately reflect the semantic correspondences between the source and target schemas.

These tools and methods are also beneficial to integration engineers. By collapsing the results of multiple matching strategies into a single metric, the amount of information that must be digested by the integration engineer prior to accepting or rejecting matches is reduced. Further, by providing the ability to filter the displayed potential matches, the integration engineer has greater control over the amount of displayed information and the nature of the displayed information.

Further, these tools and methods provide a mechanism for refining the match parameters while performing schema matching. Within existing schema matching tools, the match parameters could only be tuned between schema matching tasks. These tools and methods generate stronger potential matches, thereby quickly honing in on the desired solution.

### BRIEF DESCRIPTION OF THE DRAWINGS

The accompanying drawings, which are incorporated in and constitute part of the specification illustrate embodiments of the invention and, together with the general description given above and the detailed description of the embodiments given below, serve to explain the principles of the present invention. In the drawings:

FIG. 1 is an exemplary source and target schemata expressed in XML Schema formalism;

FIG. 2 is an exemplary source and target schemata expressed through directed graphs;

FIG. 3 is an exemplary match matrix that corresponds to the exemplary source and target schemata in FIG. 1 and FIG. 2;

FIG. 4 is an exemplary schema matching tool that practices an embodiment of present invention;

FIG. 5 is an exemplary method of practicing an embodiment of the present invention; and

FIG. 6 is an exemplary computer architecture upon which the present invention may be implemented.

### DETAILED DESCRIPTION OF THE INVENTION

The present invention, as described below, may be implemented in many different embodiments of software, hardware, firmware, and/or the. entities illustrated in the figures. Any actual software code with the specialized control of hardware to implement the present invention is not limiting of the present invention. Thus, the operational behavior of the present invention will be described with the understanding that modifications and variations of the embodiments are possible, given the level of detail presented herein.

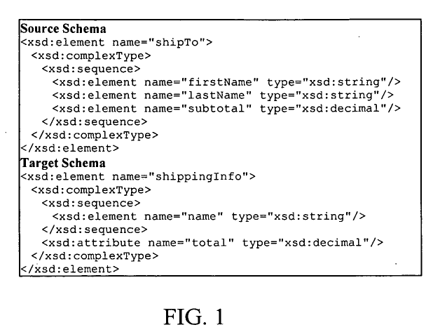

Schema matching tools generally represent a schema as a directed graph as discussed in Bernstein et al., “Industrial-Strength Schema Matching,” SIGMOD Record, vol. 33, pp. 38-43, 2004, incorporated herein by reference in its entirety. The nodes of this graph correspond to schema elements. In the relational model, these elements include relations, attributes and keys. In XML, they include elements and attributes. The present invention currently supports ERWin® physical models (a product of Computer Associates of Islandia, N.Y., see www3.ca.com), XML Schema (XSD) files, and RDF/OWL ontologies. FIG. 1 is an exemplary source and target schemata presented in XML Schema format.

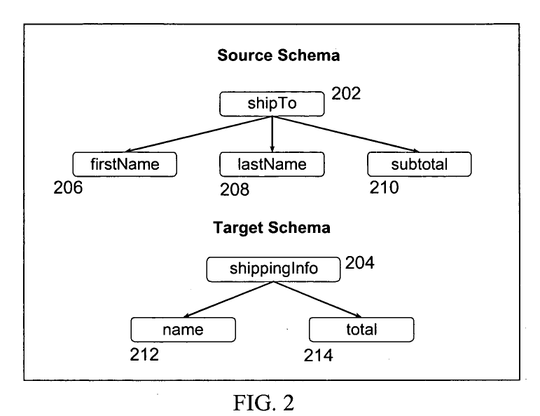

FIG. 2 is an illustration of schema graphs corresponding to the exemplary source and target schemata displayed in FIG. 1. In FIG. 2, the schema elements shipTo and shippingInfo are displayed as nodes 202 and 204 in schema graphs, and the structural relationships are represented as edges. Edges connect the shipTo element 202 to the elements firstName 206, lastName 208, and subtotal 210 nested within it. Similarly, edges connect the shippingInfo node 204 to the name element 212 and the total element 214. The present invention annotates each node in the schema graph with additional information, including its name and documentation.

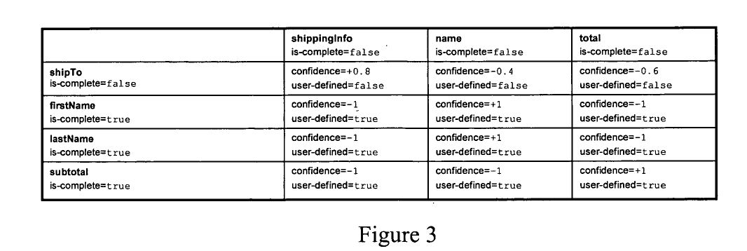

Relationships between schema elements in the source and target schemata are generally represented by a match matrix. This matrix consists of headers that reference source and target elements, a row for each source element, and a column for each target element. FIG. 3 presents an exemplary match matrix corresponding to the exemplary schema graphs in FIG. 2. The exemplary match matrix contains four rows and three columns, and each cell in the match matrix describes a potential correspondence between a source element and a target element.

The components of the match matrix are annotated with information that describes the relationship between the source and target elements. Each cell contains a confidence score, which ranges from −1 (definitely not a match) to +1 (definitely a match), and a user-defined flag. If generated automatically by the present invention, the confidence score falls in the range (−1,+1) and the user-defined flag is set to false. When the integration engineer explicitly accepts or rejects a match, the confidence score is set to ±1 and the user-defined flag is set to true. The matrix headers are annotated with an is-complete flag, which indicates whether the integration engineer has identified all semantic correspondences for that element.

### EXAMPLE 1

### An Exemplary Schema Matching Tool

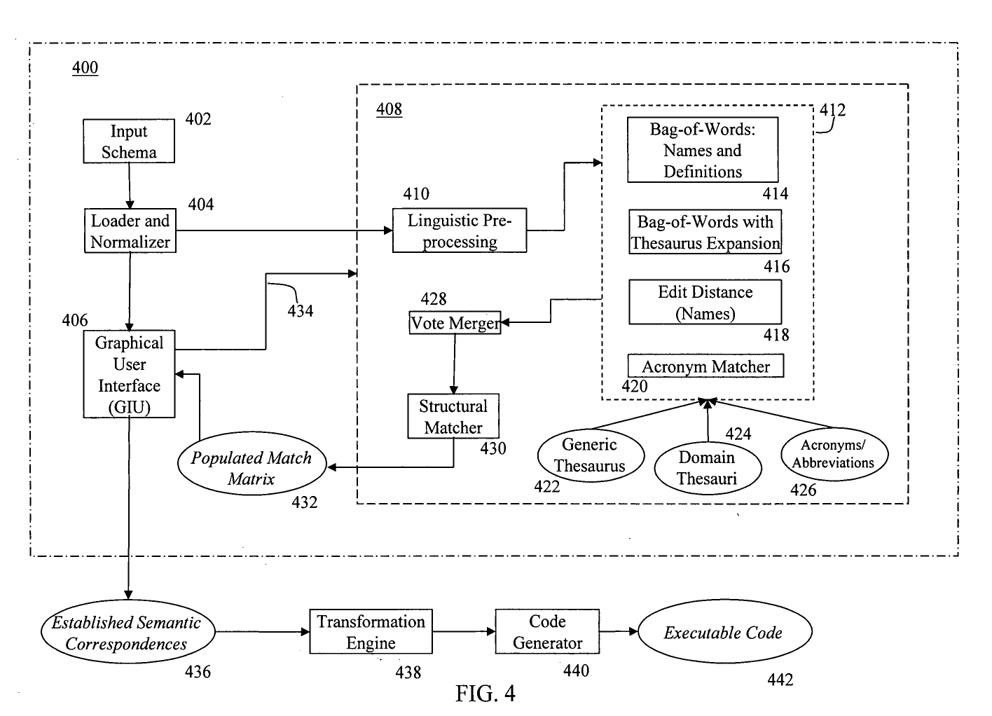

FIG. 4 is a diagram of an exemplary schema matching tool 400 that includes components for generating schema graphs, populating match matrices and displaying the schema graphs and the match matrices. For each input schema 402, the schema matching tool 400 includes a component 404 for loading and normalizing the input schema. The loader generates an in-memory representation of the input schema (in its native format), and the normalizer converts that representation into a schema graph. A different loader and normalizer component is required for each schema format to account for differences in schema elements and structural relationships across different formats. Each input schema is designated (by an integration engineer) as either a source or a target schema.

A graphical user interface (GUI) 406 displays the schema graphs hierarchically. The GUI first identifies a root for each normalized schema graph. Children of the root represent the schema elements that are directly connected to the root via a structural relationship. Additional levels of the hierarchy are populated similarly. Because there may be multiple paths from the root to a given element, that particular schema element may appear multiple times in the GUI. For example, in XML Schema, a complex type can be referenced by multiple elements, and the elements and attributes of that complex type will be repeated in the visual hierarchy.

Once the schema graphs are hierarchically displayed by the GUI 406, the integration engineer may manually populate a match matrix by drawing lines between related schema elements. For two elements manually connected in this fashion, their corresponding confidence score is set to +1. Alternatively, the integration engineer may populate the match matrix by invoking a match engine 408.

The match engine 408 first performs linguistic pre-processing 410 on names and documentation for each schema element to generate a bag-of-words. The schema graphs, and their associated bags-of-words, are then passed to a suite of match voters 412, each of which considers a different source of evidence to generate a match score between each pair of source and target elements (hereafter known as a potential match). These match voters may rely on external resources, such as a generic thesaurus 422, a domain thesaurus 424, and dictionaries of acronyms and abbreviations 426.

The suite of match voters 412 generates a set of match scores for each potential match. A vote merger 428 then collapses each set into a single confidence score based on several criteria, including an amount of evidence considered, a strength of evidence, and feedback provided by the integration engineer. These confidence scores are adjusted by a structural matcher 430 that incorporates a similarity flooding algorithm as discussed, for example, in Melnik et al., “Similarity Flooding: A Versatile Graph Matching Algorithm,” presented at Proceedings of the 18th International Conference on Data Engineering, San Jose, Calif., 2002., incorporated herein by reference in its entirety. The vote merger 428 scans all the potential matches to populate the final match matrix 432.

The final match matrix 432 is presented to the user as a collection of lines connecting the source elements to the target elements within the GUI 406. The GUI includes a number filters that limit which potential matches are shown onscreen. For example, one filter hides any potential match whose confidence score falls below some threshold value. Another filter displays only those potential matches pertaining to a given subset of the schema graph. The GUI 406 then allows the integration engineer to accept or reject potential matches, thereby setting the confidence score to ±1 and identifying semantic correspondences between the source and the target schemata.

Finally, the integration engineer can rerun the match engine 408 in order to provide feedback through link 434. The potential matches that have been explicitly accepted or rejected by the integration engineer (i.e., the identified semantic correspondences) are used to calibrate the match voters 412 and the vote merger 428. For example, match voters 412 that tend to generate a positive match score for potential matches that were accepted (and negative match scores for rejected potential matches) should be weighted more heavily by the vote merger 428.

The exemplary schema integration tool 400 may also incorporate modules that perform additional schema integration tasks. The established set of semantic correspondences 436 that are output from the exemplary schema integration tool 400 may then be passed to a transformation engine 438. The transformation engine 438 utilizes the set of semantic correspondences 436 to establish a set of transformations that define a schema mapping from the source schema to the target schema. The set of transformations may then be passed to a code generator 440, which assembles executable code 442 that executes the schema mapping defined by the transformation engine 438. By invoking this executable code, the code generator 440 may generate a data instance on the target schema from a specified element within the source schema.

### Linguistic Pre-Processing

The linguistic pre-processing 410 is necessary to apply match voters based on natural-language processing techniques to the target and source schemata. Text strings in both the source and target schemata are first tokenized to split words that are not divided by spaces into distinct words. Due to the frequency with which CamelCase appears in the schemata, tokenization first breaks text strings within the source and target schemata into separate words at the boundary between an upper-case and a lower-case letter (e.g., ‘firstName’ becomes ‘first Name’). Tokenization also removes all punctuation. The tokenized text thus contains only letters, numbers and white space.

The linguistic pre-processing 410 then replaces all capital letters with lower-case letters, removes plural suffixes and verb conjugations (for example, ‘reading books’ becomes ‘read book’), and removes any words that appear on a pre-defined list, (such as ‘a’ and ‘for’). These words, known as “stop-words,” are too common to be useful for linguistic pre-processing. The output of the four steps of linguistic pre-processing 410 is referred to as normalized text.

Further, the linguistic pre-processing 410 identifies a frequency with which each normalized word appears in the tokenized source or target schema element text. By assuming that rarely-used words are more significant than words that appear frequently, the linguistic pre-processing 410 defines a word frequency function freq(wd) to map each word wd to the number of times it appears in normalized text. The word frequency is defined as

freq(wd)→N. (1)

A word weight associated with each word is inversely proportional to the number of times it appears within the source and target schemata. In an ideal case, a word appears exactly once in the source schema and once in the target schema, or twice total. Based on these observations, a weight function wt(wd) is defined as

$$wt ( wd ) = \frac{2}{freq ( wd )} . \qquad ( 2 )$$

### Generic Match Voters

Match voters 412 consider various sources of evidence to generate a match score for each potential match. The match score is a function of both the strength of evidence indicating that the pair of elements match (i.e., positive evidence) and the total amount of evidence available (i.e., total evidence). Thus, if there were an infinite amount of positive evidence, the match score should equal +1. If there were no positive evidence, but an infinite amount of negative evidence, the match score should equal −1. Finally, if there were no evidence of either type, the match score should be zero.

For a given potential match under consideration by a generic match voter, let poe represent the amount of positive observed evidence, and let toe represent the total observed evidence. However, there exists some small probability x that the two schema elements match without examining any evidence. This indirect evidence must be factored into the assessment to calculate the combined positive evidence pe and total evidence te, defined as

pe=x+k×poe (3)

te=1+k×toe. (4)

In equations (3) and (4), k is a scaling factor that indicates the level of trust placed in the evidence by the match voter. An evidence ratio er, representing a ratio of positive evidence to total evidence, is defined as

$$er = \frac{pe}{te} . \qquad ( 5 )$$

A weighted evidence ratio wer then scales the evidence ratio from the interval [0, 1] to the interval [1, e]. When the weighting factor j is one, this is a linear transformation, and for large values of j, this represents a sub-linear transformation. The weight evidence ratio is defined as

wer=er^{1/j}(e−1)+1. (6)

An evidence factor ef, measuring the amount of evidence by mapping the positive evidence from the interval [0, ∞) to the interval [e, 1], is defined as

ef=(1+pe)^{1/pe}. (7)

The match score ms is then defined as a natural log of q ratio between wer and ef, and it is guaranteed to fall in the interval (−1, +1). It takes the form

$$ms = ln ( \frac{wer}{ef} ) . \qquad ( 8 )$$

Table 1 provides partial results of a limit analysis of the match score (defined in Equation (8)), as the positive and total evidence approach 0 and infinity. The final column provides some insight into the derivation of Equations (5)-(8).

TABLE 1
Relationship between evidence and match score

| pe | te | Er | ms | = |
|---|---|---|---|---|
| 0 | ∞ | 0 | −1 | $ln [ \frac{1}{e} ]$ |
| 0 | 0 | 1 | 0 | $ln [ \frac{e}{e} ]$ |
| ∞ | ∞ | 1 | 1 | $ln [ \frac{e}{1} ]$ |

Suitable values must also be determined for the parameters j, k, and x that appear in Equations (3)-(8). The final parameter x is needed to ensure that the match score tends to zero in the absence of observed evidence. The analysis of Equations (3)-(8) has not determined the explicit functional dependence of x on j. However, after numerous experiments, the dependence of x on j may be taken as

$$x \approx {e}^{\frac{- ln j}{1.5}} when j \geq 7. \qquad ( 9 )$$

The values of the remaining two parameters j and k depend on the match voters under consideration. Generally speaking, j controls how much positive evidence is required for the match voters to generate a match score:, greater than zero, and k amplifies the observed evidence.

### Bag-of-Words Match Voters

One strategy used to identify similar documents is to determine the extent to which a given pair of documents shares common words. This approach may be applied to schema matching by treating each schema element as a document and applying a bag-of-words match voter 414 to the corresponding documents.

For a given schema element, its corresponding schema document contains the normalized text appearing in the element's documentation and name. Because of the importance of an element's name, this particular normalized text may be added to the document twice. This schema document is then reduced to a bag-of-words (i.e., a set of words in which a given word can appear multiple times). The evidence represented by bag-of-words Bₛ is computed as follows, where the weight function is defined in Equation (2), above:

$$ev ( B ) = {\sum }_{wd ∈ B} wt ( wd ) . \qquad ( 10 )$$

For a given potential match, the positive evidence poe is based on the intersection of the corresponding bags, and the total evidence toe is based on the union of the corresponding bags, as given below:

poe(s, t)=ev(Bₛ∩Bₜ) (11)

toe(s,t)=ev(Bₛ∪Bₜ). (12)

The computed positive evidence and total evidence may then be input into Equations (5)-(8) to determine the corresponding match score for the bag-of-words match voter 414. The match voters 412 also support the inclusion of evidence external to the source and target schemata. A second match voter 416 utilizes bag-of-words match voter augmented with a thesaurus. In this case, all synonyms of a given word are added to the corresponding bag-of-words if the word appears in the thesaurus. Once the bags have been augmented with synonyms, the weight function in Equation (2) must be re-evaluated. Otherwise, the thesaurus-based bag-of-words match voter 416 is identical to the normal bag-of-words match voter 414.

Values of j and k must be determined for the bag-of-words match voter 414 and the thesaurus-based bag-of-words match voter 416. A value of j=20 seems to work well in practice for both bag-of-words match voters. Given the trade-off between precision and recall, the match voters 414 and 416 err on the side of recall, because it is easier for an integration engineer to reject false matches than to identify false non-matches. A value of k=3 appears to work well for the basic bag-of-words matcher 414, and k=1 appears to work well when using a thesaurus 416. The intuition behind using a smaller k is that one expects to have more total evidence with the thesaurus, and therefore one does not need to amplify the effect of the evidence.

The suite of match voters 412 may also incorporate an edit-distance match voter 418 that matches the names of schema elements using a version of the Levenshtein edit distance algorithm that has been modified to generate a match score in the interval (−1, +1) (see Levenshtein, “Binary codes capable of correcting deletions, insertions, and reversals,” Doklady Akademii Nauk SSSR, 163(4):845-848, 1965 (Russian), English translation in Soviet Physics Doklady, 10(8):707-710, 1966, incorporated herein in its entirety). Further, an acronym-based and abbreviation-based match voter 420 may be included in the suite of match voters 412.

### Voter Merging Techniques

The vote merger 428 combines multiple match scores into a single confidence score. This confidence score is based on multiple factors including the value of each match voter, the amount of evidence available to each match voter 412, and the strength of the evidence observed by each match voter 412. The vote merger 428 generates a single confidence value for each potential correspondence.

The basic vote-merging algorithm is a weighted average of the match scores generated by each match voter. The basic algorithm defines the match score for a given match voter v as msᵥ, and it defines V is the set of all match voters. The general equation for the confidence score is the following, where wt(v) represents the weight assigned to match voter v:

$$conf = \frac{{\sum }_{v ∈ V} wt ( v ) \times {ew}_{v} \times {ms}_{v}}{{\sum }_{v ∈ V} wt ( v ) \times {ew}_{v}} . \qquad ( 13 )$$

In general, the evidence weight ew scales from zero (in the absence of evidence), to one (given infinite evidence). Thus, any evidence weight function must map the total evidence te to the interval [0, 1]. The following analog of Equation (7) satisfies the above condition:

$$ew = {( 1 + \frac{1}{te} )}^{te} . \qquad ( 14 )$$

Equation (14) preserves multiple values for each match voter. However, the match score calculated in Equation (8) is close to zero when there is little total evidence, and close to ±1 when there is ample evidence. Given this observation, the absolute value of the match score represents the evidence weight. Assuming equal match voter weights, the confidence score thus simplifies to the following expression:

$$conf = \frac{{\sum }_{v ∈ V} \vert {ms}_{v} \vert \times {ms}_{v}}{{\sum }_{v ∈ V} \vert {ms}_{v} \vert} . \qquad ( 15 )$$

### Machine Learning

The preceding simplification assumes that each match voter is given equal weight when merging. Once the integration engineer has accepted some correct matches, and rejected other incorrect matches, the weights assigned to each match voter may be calibrated using machine learning.

In the absence of any feedback, wt(v)=1 for every match voter vεV. To apply feedback through machine learning, the schema-matching tool 400 first establishes the set UDM of user-defined matches. The confidence score of every element of this set is necessarily ±1. The vote merger 428 then iterates over the elements of set UDM to determine a new weight for each match voter:

$$wt ( v ) = \frac{{\sum }_{m ∈ UDM} {ms}_{v} ( m ) \times conf ( m )}{{\sum }_{m ∈ UDM} \vert conf ( m ) \vert} + 1. \qquad ( 16 )$$

The denominator in Equation (16) represents the number of matches accepted and rejected by the integration engineer. If the match voter assigns a positive match score to each actual match and a negative match score to each non-match, then the numerator is a sum of positive values and the weight for that match voter increases. Similarly, if the match voter assigns negative match scores to actual matches and positive match scores to non-matches, the numerator is a sum of negative values and the weight decreases. If the match voter uniformly generates a match score of zero, its weight remains one.

The weights assigned to each word in a bag-of-words match voter 414 (or the thesaurus-based bag-of-words match voter 416) can be similarly adjusted based on the feedback from the integration engineer. For a given match m, let s be the source element referenced by m and let t be the target element. The bag-of-words Bₘ associated with m is defined as follows:

Bₘ=Bₛ ∪ Bₜ. (17)

The vote merger 428 then defines freq(wd, Bₘ) to be the number of times wd appears in Bₘ. Based on this definition, the initial word weight is rewritten as follows, where M is the set of all possible matches:

$${( {\sum }_{m ∈ M} \frac{freq ( wd , {B}_{m} )}{2} )}^{- \frac{1}{2}} . \qquad ( 18 )$$

This word-weight calculation is roughly equivalent to computing the total number of occurrences of the word in the source and target schemata. However, by calculating the word weight in this manner, the vote merger 428 accounts for three types of matches: (i) those for which the match voter gave correct answers, (ii) those for which the match voter gave incorrect answers, and (iii) those for which the integration engineer has not provided feedback. In the presence of feedback, Equation (18) is rewritten as

$$wt ( wd ) = {( {\sum }_{m ∈ M - UDM} \frac{freq ( wd , {B}_{m} )}{2} )}^{- \frac{1}{2}} \times ( {\prod }_{m ∈ UDM} freq {( wd , {B}_{M} )}^{{ms}_{v} \times conf ( m )} ) . \qquad ( 19 )$$

Equation (19) is thus equal to Equation (18) when UDM is the empty set, and the weight of a word appearing in unconfirmed matches is inversely proportional to its overall frequency. Further, each potential match is considered exactly once. Words that contribute to correctly identified matches or non-matches increase the word weight, and words that contribute to incorrectly identified matches or non-matches decrease the word weight.

### Graphical User Interface (GUI)

The exemplary schema-matching tool 400 provides an intuitive, graphical user interface (GUI) 406 with which to display the populated match matrix. The source schema graph is displayed on the left side of the screen as a schema tree, and the target schema graph is displayed on the right side of the screen. A line connecting a source element to a target element represents each potential match as a schema tree. The lines are color-coded to indicate the confidence score associated with the potential match: green indicates high confidence (close to +1), red indicates low confidence (−1), and yellow indicates a confidence score close to zero.

Several filters augment the GUI 406 and allow the integration engineer to focus on particular potential matches. These filters are loosely categorized as link filters and node filters. A link filter is a predicate that is evaluated against each potential match to determine whether the potential match should be displayed. A node filter determines if a given schema element should be enabled. An enabled element is displayed along with its links, while a disabled element is grayed out and its links are not displayed.

The GUI 406 currently supports three types of link filters. First, a confidence filter displays only those links whose associated confidence score exceeds some specified threshold. The potential matches that are explicitly accepted by the integration engineer are always displayed by the confidence filter. Similarly, the potential matches that are explicitly rejected by the integration engineer are never displayed. The integration engineer controls the specified threshold using a sliding scale.

When activated, the source filter displays only those links for which the user-defined flag is set to a specific value (either true or false). Thus, the source filter allows the integration engineer to see only those potential matches that have been explicitly accepted (or rejected).

A best filter displays those links for which the associated confidence score is a local maximum. For either the source element or target element, a potential match cannot exist with a larger confidence score. Multiple links can still connect to a given schema element, but one of the links will be a local maximum with respect to the given element.

The node filters include a depth filter and a sub-tree filter. The depth filter enables only those schema elements that appear at or above a given depth in the schema graph. For example, in an ER model, entities appear at level one, while attributes are at level two. Thus, by using the depth filter, the engineer can focus exclusively on matching entities. The depth filter also supports a common matching strategy in which the integration engineer identifies several high-level matches before focusing on a specific sub-tree of the schema graph.

The sub-tree filter enables only those elements that appear within an indicated sub-tree. Once several high-level matches are identified, the integration engineer can invoke the sub-tree filter to focus on a specific sub-tree of the schema graph. A combination of the node and the sub-tree filters, can reduce an otherwise overwhelming number of leaf-level links.

The GUI 406 also supports marking a particular sub-tree as complete. This action is, in some sense, the inverse of focusing on a sub-tree. Once a sub-tree is marked as complete, it is completely disabled (even if enabled by other filters). Marking a sub-tree as complete has an important side-effect: all of the currently visible links are automatically accepted and any links that are not visible are rejected. This side-effect represents a convenient mechanism for updating large portions of the match matrix so that machine learning can proceed quickly. Marking the sub-tree as complete also updates a proportion of schema elements that have been completely matched within the GUI 406.

### EXAMPLE 2

### Method for Semi-Automatic Schema Matching

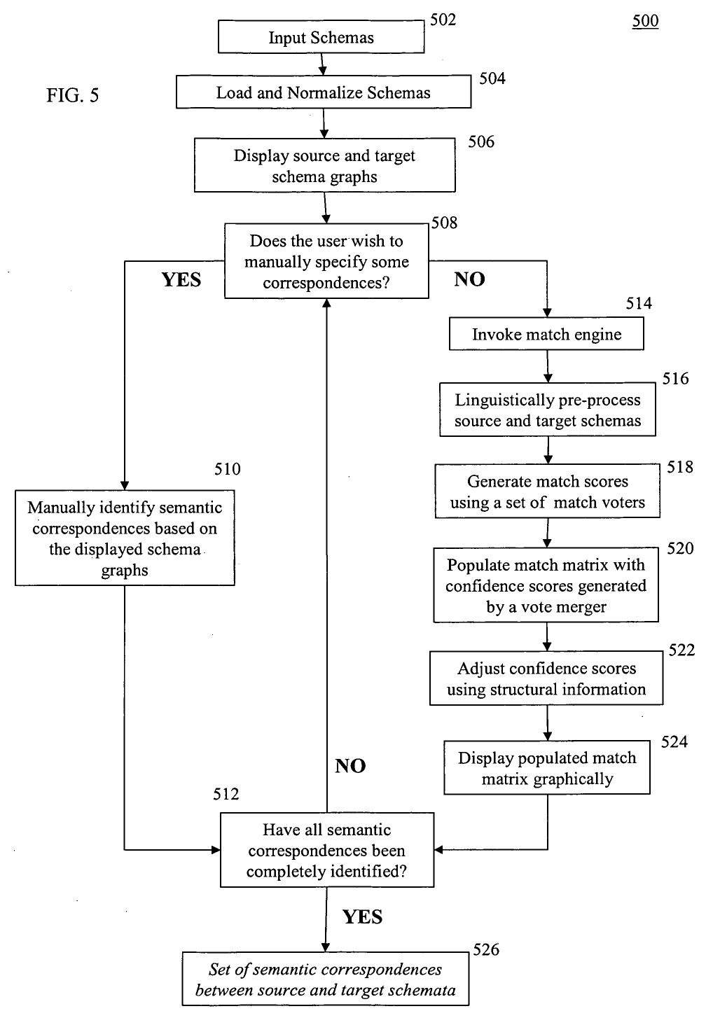

FIG. 5 is a detailed illustration of an exemplary method 500 that generates schema graphs, populates match matrices and displays schema graphs and match matrices. Input schemata, comprising at least one potential source schema and at least one potential target schema, are provided by step 502 of the exemplary method 500. The input schemata then pass to step 504, which processes the input schemata through a loader and a normalizer. The loader of step 504 generates an in-memory representation of each input schema (in its native format), and the normalizer then converts the representation into a corresponding schema graph. A different loader and normalizer are required within step 504 for each schema format to account for differences in schema elements and structural relationships across different formats. Once the schemata are loaded and normalized within step 504, the integration engineer designates the schemata as either source schemata or target schemata.

The source and target schema graphs are then displayed in hierarchical fashion in step 506 through a graphical user interface (GUI). For each source and target schema, the GUI of step 506 identifies a root for the schema. Children of the root represent schema elements that are directly connected to the root via a structural relationship. Additional levels of the displayed: hierarchy may be populated similarly. As there may be multiple paths from the root to a given element, the schema element may appear multiple times in the GUI. For example, a complex XML Schema type can be referenced by multiple elements, and the elements and attributes of that complex type will be repeated in the visual hierarchy.

Once the schema graphs are hierarchically displayed within step 506, the integration engineer must determine whether to manually identify semantic correspondences from the source and target schema graphs in step 508. If the integration engineer were to identify manually the semantic correspondences, then the integration engineer would draw lines between related source and target schema elements in step 510 to populate the match matrix. For two elements manually connected in this fashion, a corresponding confidence score is set to +1. Once a number of semantic correspondences have been manually identified, the integration engineer must determine in step 512 whether the exemplary method has completely identified all semantic correspondences.

If the semantic correspondences were automatically identified within step 508, then the integration engineer would invoke a match engine within step 514 to populate the match matrix. Once invoked, the match engine performs linguistic pre-processing on the source and target schemata in step 516. The linguistic pre-processing step 516 operates on names and documentation of each schema element to generate a corresponding bag-of-words for that schema element. The schema elements and their corresponding bags-of-words then pass to a suite of match voters in step 518, which consider different sources of evidence to generate a set of match scores between each pair of source and target schema elements (known hereafter as a potential match). The set of match scores may depend on either a strength of evidence considered or an amount of evidence considered. The match voters in step 518 may also rely on external resources, such as generic and domain thesauri and dictionaries of acronyms and abbreviations.

The set of match scores for each semantic correspondence is then passed to a vote merger in step 520, which collapses each set of match scores into a single confidence score for each potential match. The confidence score is based on several criteria, including the amount of evidence considered, the strength of evidence considered, and feedback provided by the integration engineer. The vote merger within step 520 is applied to each potential match to populate a final match matrix. The confidence scores within the final match matrix are then adjusted using structural information in step 522, and the adjustment in step 522 may utilize a similarity flooding algorithm as discussed previously.

The final match matrix is then presented to the user as a collection of lines connecting the source schema elements to the target schema elements within the GUI in step 524. A number of filters may be applied to the final match matrix to limit which potential matches are displayed on the GUI. For example, one filter hides any potential match whose confidence score falls below a specified threshold value. An additional filter displays only those potential matches pertaining to a given subset of the source and/or target schema graph. Once the potential matches are displayed on the GUI, the integration engineer must determine in step 512 whether the exemplary method has completely identified all semantic correspondences.

If the integration engineer determines that all semantic correspondences have been identified in step 512, then the set of identified semantic correspondences is output by the exemplary method in step 526. Otherwise, the exemplary method passes back into step 508, in which the integration engineer determines whether to identify additional semantic correspondences manually or to invoke the match engine to identify additional semantic correspondences automatically.

If the integration engineer elects to identify semantic correspondences manually, then the integration engineer draws lines between related source and target schema elements in step 510 to populate the match matrix. The manual identification of semantic correspondences may be aided by a set of previously-identified semantic correspondences and by the match matrix displayed within step 524.

If the integration engineer elects to identify semantic correspondences automatically, then the match engine is re-invoked within step 514 and the source and target schemata are linguistically pre-processed in step 516. The previously-identified semantic correspondences provide feedback that calibrates the match voters 518 and the vote merger 520. For example, match voters 518 that tend to generate a positive match score for matches that were accepted (and negative match scores for rejected matches) should be weighted more heavily by the vote merger 516. The resulting set of confidence scores are adjusted for structural information in step 522, and are displayed graphically by the GUI in step 524. The integration engineer then determines whether additional semantic correspondences are to be identified in step 512, and if so, whether these additional correspondences are to be identified manually or automatically using the match engine. This process may continue in an iterative fashion, with each successive set of identified semantic correspondences providing feedback to the match engine and to the manual identification of semantic correspondences.

### Exemplary Computer Systems

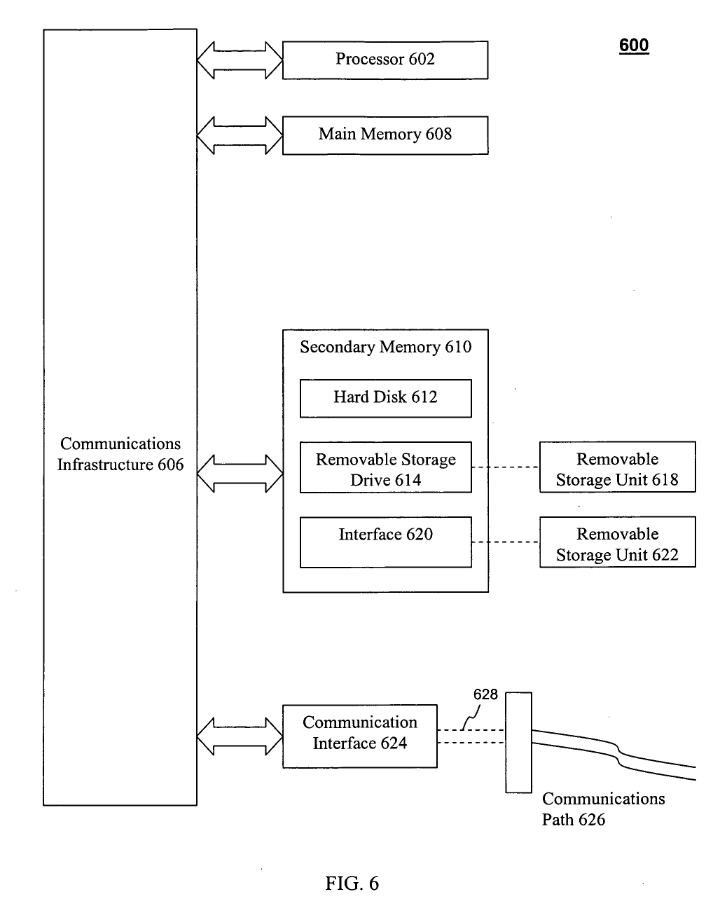

FIG. 6 is a diagram of an exemplary computer system 600 upon which the present invention may be implemented. The exemplary computer system 600 includes one or more processors, such as processor 602. The processor 602 is connected to a communication infrastructure 606, such as a bus or network. Various software implementations are described in terms of this exemplary computer system. After reading this description, it will become apparent to a person skilled in the relevant art how to implement the invention using other computer systems and/or computer architectures.

Computer system 600 also includes a main memory 608, preferably random access memory (RAM), and may include a secondary memory 610. The secondary memory 610 may include, for example, a hard disk drive 612 and/or a removable storage drive 614, representing a magnetic tape drive, an optical disk drive, etc. The removable storage drive 614 reads from and/or writes to a removable storage unit 618 in a well-known manner. Removable storage unit 618 represents a magnetic tape, optical disk, or other storage medium that is read by and written to by removable storage drive 614. As will be appreciated, the removable storage unit 618 can include a computer usable storage medium having stored therein computer software and/or data.

In alternative implementations, secondary memory 610 may include other means for allowing computer programs or other instructions to be loaded into computer system 600. Such means may include, for example, a removable storage unit 622 and an interface 620. An example of such means may include a removable memory chip (such as an EPROM, or PROM) and associated socket, or other removable storage units 622 and interfaces 620, which allow software and data to be transferred from the removable storage unit 622 to computer system 600.

Computer system 600 may also include one or more communications interfaces, such as communications interface 624. Communications interface 624 allows software and data to be transferred between computer system 600 and external devices. Examples of communications interface 624 may include a modem, a network interface (such as an Ethernet card), a communications port, a PCMCIA slot and card, etc. Software and data transferred via communications interface 624 are in the form of signals 628, which may be electronic, electromagnetic, optical or other signals capable of being received by communications interface 624. These signals 628 are provided to communications interface 624 via a communications path (i.e., channel) 626. This channel 626 carries signals 628 and may be implemented using wire or cable, fiber optics, an RF link and other communications channels. In an embodiment of the invention, signals 628 comprise data packets sent to, processor 602. Information representing processed packets can also be sent in the form of signals 628 from processor 602 through communications path 626.

The terms “computer program medium” and “computer usable medium” are used to refer generally to media such as removable storage units 618 and 622, a hard disk installed in hard disk drive 612, and signals 628 which provide software to the computer system 600.

Computer programs are stored in main memory 608 and/or secondary memory 610. Computer programs may also be received via communications interface 624. Such computer programs, when executed, enable the computer system 600 to implement the present invention as discussed herein. In particular, the computer programs, when executed, enable the processor 602 to implement the present invention. Where the invention is implemented using software, the software may be stored in a computer program product and loaded into computer system 600 using removable storage drive 614, hard drive 612 or communications interface 624.

### Conclusion

The present invention provides a schema-matching tool that includes components for generating schema graphs, populating match matrices and displaying the schema graphs and the match matrices. The present invention also provides a method for schema matching that generates schema graphs, populates match matrices and displays the schema graphs and the match matrices.

The present invention combines a match engine for populating a match matrix with a user interface for displaying and modifying that matrix. The match engine generates match scores based on both the ratio of positive evidence to total evidence and the quantity of available evidence. The benefit of this approach is that multiple pieces of information are passed to the vote merger.

The vote merger combines the match scores generated by the match voters into a single confidence score based on match scores, total evidence, strength of evidence, and voter weights. The present invention adjusts the confidence score based on the amount of evidence available to each match voter. Because the final score ranges from −1 to +1, the confidence score can intuitively combine the observed evidence with the total available evidence.

The exact weighting parameters used by the match voters and vote merger are updated while performing a schema matching task. The present invention supports real-time parameter tuning to improve the accuracy of the final confidence score. Further, the graphical user interface of the present invention can communicate information to the match engine pertaining to which potential matches have been accepted or rejected by the integration engineer.

The integration engineer is able to visualize the match matrix using a graphical interface. This interface includes several filters that help the engineer to focus his attention on a particular region of interest based on common strategies for schema matching. The integration engineer is also able to accept and reject a large number of potential matches simultaneously by marking a portion a schema graph as complete. This allows the system rapidly to collect information needed to learn match parameters.

The foregoing description of the specific embodiments will so fully reveal the general nature of the invention that others can, by applying knowledge within the skill of the art (including the contents of any references cited herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What we claim is:

1. A schema matching tool for establishing correspondences between data elements on disparate schemata, comprising:
means for inputting at least one source schema and at least one target schema;
means for generating a set of match scores representing potential correspondences between elements in the source schemata and elements in the target schemata;
means for combining the set of match scores to yield a confidence value for each of the potential correspondences; and
means for displaying each confidence value.

2. The schema matching tool of claim 1, further comprising means for pre-processing the source and target schemata.

3. The schema matching tool of claim 2, wherein said pre-processing means comprises at least one of:
(i) means for tokenizing text strings of the source and the target schemata;
(ii) means for eliminating capitalization from the text strings of the source and the target schemata;
(iii) means for removing common morphological and inflectional endings from the text strings of the source and the target schemata;
(iv) means for eliminating specified words from the text strings in the source and the target schemata; and
(v) means for assessing the frequency at which specific words appear in the text strings of the source and the target schemata.

4. The schema matching tool of claim 1, wherein the set of match scores for each of the potential correspondences reflects at least one of:
(i) a strength of evidence indicating the potential correspondence; and
(ii) an amount of evidence indicating the potential correspondence.

5. The schema matching tool of claim 1, wherein the means for generating the set of match scores comprises processing the source schemata and the target schemata by processing the text used to describe the schema elements.

6. The schema matching tool of claim 4, wherein the natural-language processing techniques include at least one of:
(i) means for matching words within the text of the source schemata and the target schemata;
(ii) means for utilizing a thesaurus to match synonyms within the text of the source schemata and the target schemata;
(iii) means for matching names within the text of the source schemata and the target schemata; and
(iv) means for matching acronyms within the text of the source schemata and the target schemata.

7. The schema matching tool of claim 1, wherein the confidence value for each of the potential correspondences reflects at least one of:
(i) the strength of evidence indicating the potential correspondence; and
(ii) the amount of evidence indicating the potential correspondence.

8. The schema matching tool of claim 1, wherein the means for combining the set of match scores further comprises adaptively determining the confidence value for each of the potential correspondences in response to previously established semantic correspondences between the elements in the source schemata and the elements in the target schemata.

9. The schema matching tool of claim 1, wherein the means for displaying the confidence values further comprises manually linking the elements of the source schemata with the elements of the target schemata to generate the semantic correspondences.

10. The schema matching tool of claim 1, further comprising means for decomposing the source schemata into a source schema graph and corresponding source schema tree and means for decomposing the target schemata into a target schema graph and corresponding target schema graph.

11. The schema matching tool of claim 10, wherein the means for displaying the confidence values further comprises applying at least one of:
(i) a link filter; and
(ii) a node filter to display the confidence value for each of the potential correspondences as a link on a graphical user interface.

12. The schema matching tool of claim 11, wherein the link filter further comprises at least one of:
(i) a filter for displaying the links whose confidence value exceeds a specified threshold;
(ii) a filter for displaying the links associated with a user-specified flag; and
(iii) a filter for displaying the link to a specific schemata element with a maximum confidence value.

13. The schema matching tool of claim 11, wherein the node filter further comprises at least one of:
(i) a filter to enable the links according to a specified depth in the source schema tree and the target schema tree; and
(ii) a filter that enables the links associated with a particular sub-tree of the source schema tree and the target schema tree.

14. The schema matching tool of claim 10, wherein the means for displaying the confidence values further comprises at least one of:
(i) means for selecting individual links to establish the semantic correspondence between the source schemata and the target schemata;
(ii) means for marking the selected links as completed;
(iii) means for marking individual sub-trees of the source and the target schema trees as completed; and
(iv) means for modifying display properties of the completed links and the completed sub-trees.

15. The schema matching tool of claim 14, further comprising means for utilizing the semantic correspondences to establish a set of transformations that define a schema mapping from the source schemata to the target schemata.

16. The schema matching tool of claim 15, further comprising means for assembling executable code that accepts a data instance on the source schemata and invokes the schema mapping to generate a data instance on the target schemata.

17. A method for establishing correspondences between data elements on disparate schemata, comprising:
inputting at least one source schema and at least one target schema;
generating a set of match scores representing potential correspondences between elements in the source schemata and elements in the target schemata;
combining the set of match scores to yield a confidence value for each of the potential correspondences; and
displaying each confidence value.

18. The method of claim 17, further comprising pre-processing the source and target schemata.

19. The method of claim 18, wherein the pre-processing step comprises at least one of:
(i) tokenizing text strings of the source and the target schemata;
(ii) eliminating capitalization from the text strings of the source and the target schemata;
(iii) removing common morphological and inflectional endings from the text strings of the source and the target schemata;
(iv) eliminating specified words from text strings in the source and the target schemata; and
(v) assessing the frequency at which specific words appear in the text strings of the source and the target schemata.

20. The method of claim 17, wherein the set of match scores for each of the potential correspondences reflects at least one of:
(i) a strength of evidence indicating the potential correspondence; and
(ii) an amount of evidence indicating the potential correspondence.

21. The method of claim 17, wherein the generating step comprises processing the source schemata and the target schemata by processing the text used to describe the schema elements.

22. The method of claim 20, wherein the natural-language processing techniques include at least one of:
(i) matching words within the text of the source schemata and the target schemata;
(ii) utilizing a thesaurus to match synonyms within the text of the source schemata and the target schemata;
(iii) matching names within the text of the source schemata and the target schemata; and
(iv) matching acronyms within the text of the source schemata and the target schemata.

23. The method of claim 17, wherein the confidence value for each of the potential correspondences between elements in the source schemata and elements in the target schemata reflects at least one of:
(i) the strength of evidence indicating the potential correspondence; and
(ii) the amount of evidence indicating the potential correspondence.

24. The method of claim 17, wherein the combining step comprises adaptively determining the confidence value for each of the potential correspondences in response to previously established semantic correspondences between the elements in the source schemata and the elements in the target schemata.

25. The method of claim 17, wherein the displaying step comprises manually linking the elements of the source schemata with the elements of the target schemata to generate the semantic correspondences.

26. The method of claim 17, wherein the displaying step comprises applying at least one of:
(i) a link filter; and
(ii) a node filter to display the confidence value for each of the potential correspondences as a visible link on a graphical user interface (GUI).

27. The method of claim 26, wherein the link filter further comprises at least one of:
(i) a filter for displaying the links whose confidence value exceeds a specified threshold;
(ii) a filter for displaying the links associated with a user-specified flag; and
(iii) a filter for displaying the link to a specific schemata element with a maximum confidence value.

28. The method of claim 17, further comprising decomposing the source schemata into a source schema graph and corresponding source schema tree and decomposing the target schemata into a target schema graph and corresponding target schema graph.

29. The method of claim 26, wherein the node filter further comprises at least one of:
(i) a filter to enable the links according to a specified depth in the source schema tree and the target schema tree; and
(ii) a filter that enables only the links associated with a particular sub-tree of the source schema tree and the target schema tree.

30. The method of claim 28, wherein the displaying step comprises at least one of:
(i) selecting individual links to establish the semantic correspondence between the source schemata and the target schemata;
(ii) marking the selected links as completed;
(iii) marking individual sub-trees of the source and the target schema trees as completed; and
(iv) modifying display properties of the completed links
